(19) United States
(12) Patent Application Publication
(10) Pub. No.: US 2012/0219743 A1
(43) Pub. Date: Aug. 30, 2012

(54) POLYMER COMPOSITION COMPRISING TUNGSTEN TREATED TITANIUM DIOXIDE HAVING IMPROVED PHOTOSTABILITY

(75) Inventors: John Davis Bolt, Kingston, TN (US); Eugene Michael McCarron, III, Chadds Ford, PA (US); Charles David Musick, Waverly, TN (US)

(73) Assignee: E.I. DuPont de Nemours and Company, Wilmington, DE (US)

(21) Appl. No.: 13/505,475

(22) PCT Filed: Nov. 9, 2010
(86) PCT No.: PCT/US10/55893

§ 371 Date: May 2, 2012

Related U.S. Application Data
(60) Provisional application No. 61/384,873, filed on Sep. 21, 2010.

(51) Int. Cl. B32B 1/08; C08L 23/06; C08K 3/10

(52) U.S. Cl. 428/36.9; 524/406; 521/143

(57) ABSTRACT

This disclosure relates to a polymer composition comprising an inorganic particle, wherein the inorganic particle comprises at least about 0.002% of tungsten, based on the total weight of the inorganic particle, and has a photostability ratio (PSR) of at least about 2, as measured by the Ag⁺ photoreduction rate, and color as depicted by an L* of at least about 97.0, and b* of less than about 4. The disclosure also relates to plastic parts prepared from these compositions.

### BACKGROUND OF THE DISCLOSURE

1. Field of the Disclosure

The present disclosure relates to a polymer composition comprising titanium dioxide, and in particular to a shaped article prepared from the polymer composition comprising tungsten treated titanium dioxide.

2. Background of the Disclosure

High molecular weight polymers, for example, hydrocarbon polymers and polyamides, are melt extruded into shaped structures such as tubing, pipe, wire coating or film by well-known procedures wherein a rotating screw pushes a viscous polymer melt through an extruder barrel into a die in which the polymer is shaped to the desired form, and is then subsequently cooled and solidified into a product, that is, the extrudate, having the general shape of the die. In film blowing processes, as an extruded plastic tube emerges from the die the tube is continuously inflated by air, cooled, collapsed by rolls and wound up on subsequent rolls.

Inorganic particles are added to the polymers. In particular, titanium dioxide pigments, are added to polymers for imparting whiteness and/or opacity to the finished article. To deliver other properties to the molded part or film, additional additives are incorporated into the processing step.

Atypical method for combining inorganic particles and polymers utilizes dropping the treated particle and polymer through a feed tube into the feed barrel or into the side stuffer of an extruder from which it is then compounded. Alternatively, the inorganic particle can be dropped with the polymer into the cavity of a rotational blender such as a Banbury.

Titanium dioxide pigments are prepared using either the chloride process or the sulfate process. In the preparation of titanium dioxide pigments by the vapor phase chloride process, titanium tetrachloride, TiCl₄, is reacted with an oxygen containing gas at temperatures ranging from about 900° C. to about 1600° C., the resulting hot gaseous suspension of TiO₂ particles and free chlorine is discharged from the reactor and must be quickly cooled below about 600° C., for example, by passing it through a conduit, i.e., flue, where growth of the titanium dioxide pigment particles and agglomeration of said particles takes place.

It is known to add various substances, such as silicon compounds and aluminum compounds, to the reactants in order to improve the pigmentary properties of the final product. Aluminum trichloride added during the process has been found to increase rutile in the final product, and silicon tetrachloride that becomes silica in the final product has been found to improve carbon black undertone (CBU), particle size and pigment abrasion. It is useful to be able to add elements to the titanium dioxide particles. However, the process and materials to be added to improve properties of the titanium dioxide particles may be hazardous.

One method of adding elements to the surface of a particle is by impregnation with a solution containing the element. This is difficult to do with pyrogenically prepared metal oxide particles since the properties of the pyrogenically produced metal oxides change upon contact with a liquid medium.

A need exists for a low cost approach for preparing polymer compositions comprising pyrogenically prepared metal oxide particles, particularly titanium dioxide particles, comprising elements such as tungsten that provide improved photostability without changing the color of the product.

### SUMMARY OF THE DISCLOSURE

In a first aspect, the disclosure provides a polymer composition comprising inorganic particles, typically inorganic metal oxide or mixed metal oxide particles, more typically titanium dioxide (TiO₂) particles, comprising at least about 0.002% of tungsten, more typically at least about 0.004% of tungsten, and still more typically at least about 0.01% of tungsten, and most typically at least about 0.05% of tungsten, based on the total weight of the inorganic particles, wherein the inorganic particles, have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, more typically inorganic metal oxide or mixed metal oxide particles, and most typically titanium dioxide particles, comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles.

In a second aspect, the disclosure provides a plastic part, such as a shaped article, prepared from a polymer composition comprising inorganic particles, typically inorganic metal oxide or mixed metal oxide particles, more typically titanium dioxide (TiO₂) particles, comprising at least about 0.002% of tungsten, more typically at least about 0.004% of tungsten, and still more typically at least about 0.01% of tungsten, and most typically at least about 0.05% of tungsten, based on the total weight of the inorganic particles, wherein the inorganic particles, have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, more typically inorganic metal oxide or mixed metal oxide particles, and most typically titanium dioxide particles, comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles.

### BRIEF DESCRIPTION OF THE DRAWING

FIG. 1 is a schematic illustration showing the process for preparing titanium dioxide (TiO₂).

### DETAILED DESCRIPTION OF THE DISCLOSURE

This disclosure relates to a polymer composition comprising inorganic particles, typically inorganic metal oxide or mixed metal oxide particles, more typically titanium dioxide (TiO₂) particles, comprising at least about 0.002% of tungsten, more typically at least about 0.004% of tungsten, and still more typically at least about 0.01% of tungsten, and most typically at least about 0.05% of tungsten, based on the total weight of the inorganic particles, wherein the inorganic particles, have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, more typically inorganic metal oxide or mixed metal oxide particles, and most typically titanium dioxide particles, comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles, and a plastic part made therefrom.

### Polymer Composition and Shaped Article:

The present disclosure provides a process for preparing a treated inorganic particle-containing, high molecular weight polymer composition and shaped articles prepared therefrom. Typically, in this process, the inorganic particle, such as titanium dioxide, may be surface treated in accordance with this disclosure. The treated particle is mixed with other components to form the polymer composition by any means known to those skilled in the art. Both dry or wet mixing may be suitable. In wet mixing, the particle may be slurried or suspended in a solvent and subsequently mixed with the other ingredients.

In one embodiment of the disclosure, the treated particle may be contacted with a first high molecular weight melt processable polymer. Any melt compounding techniques, known to those skilled in the art may be used. Generally, the treated particle, other additives and melt-processable polymer are brought together and then mixed in a blending operation, such as dry blending, that applies shear to the polymer melt to form the particle-containing, more typically pigmented, polymer. The melt-processable polymer is usually available in the form of particles, granules, pellets or cubes. Methods for dry blending include shaking in a bag or tumbling in a closed container. Other methods include blending using agitators or paddles. Treated particle, and melt-processable polymer may be co-fed using screw devices, which mix the treated particle, polymer and melt-processable polymer together before the polymer reaches a molten state. Alternately, the components may be fed separately into equipment where they may be melt blended, using any methods known in the art, including screw feeders, kneaders, high shear mixers, blending mixers, and the like. Typical methods use Banbury mixers, single and twin screw extruders, and hybrid continuous mixers.

Processing temperatures depend on the polymer and the blending method used, and are well known to those skilled in the art. The intensity of mixing depends on the polymer characteristics.

The treated particle containing polymer composition produced by the process of this disclosure is useful in production of shaped articles. The amount of particle present in the treated particle-containing polymer composition and shaped polymer article will vary depending on the end use application. However, typically, the amount of the treated particle in the polymer composition ranges from about 30 to about 90 wt. %, based on the total weight of the composition, typically, about 50 to about 80 wt. %. The amount of particle in an end use, such as a shaped article, for example, a polymer film, can range from about 0.01 to about 20 wt. %, and is typically from about 0.1 to about 15 wt. %, more typically about 5 to about 10 wt. %, based on the weight of the shaped article.

A shaped article is typically produced by melt blending the treated particle containing polymer which comprises a first high molecular weight melt-processable polymer, with a second high molecular weight melt-processable polymer to produce the polymer that can be used to form the finished article of manufacture. The treated particle containing polymer composition and second high molecular weight polymer are melt blended, using any means known in the art, as disclosed hereinabove. In this process, twin-screw extruders are commonly used. Co-rotating twin-screw extruders are available from Werner and Pfleiderer. The melt blended polymer is extruded to form a shaped article.

Inorganic particles treated in accordance with this disclosure are capable of being dispersed throughout the polymer melt. Typically the treated inorganic particle can be uniformly dispersed throughout the polymer melt. Such particles may exhibit some minor degree of clumping together within the polymer. A minor amount of the particles may also migrate to the surface of the polymer melt but any such migration would not be to a degree sufficient for the particle to qualify as a surface active material such as an antiblock agent.

In one embodiment, the disclosure relates to a polymer composition that can be used as a masterbatch. When used as a masterbatch, the polymer can provide both opacity and viscosity attributes to a polymer blend that can be utilized to form shaped articles.

This disclosure is particularly suitable for producing shaped articles such as tubing, pipes, wire coatings, and films. The process is especially useful for producing films, especially blown films.

### Treated Particle:

It is contemplated that any inorganic particle, and in particular inorganic particles that are photoactive, will benefit from the treatment of this disclosure. By inorganic particle it is meant an inorganic particulate material that becomes dispersed throughout a final product such as a polymer melt or coating or laminate composition and imparts color and opacity to it. Some examples of inorganic particles include but are not limited to ZnO, ZnS, BaSO₄, CaCO₃, TiO₂, Lithopane, white lead. SrTiO₃, etc.

In particular, titanium dioxide is an especially useful particle in the processes and products of this disclosure. Titanium dioxide (TiO₂) particles useful in the present disclosure may be in the rutile or anatase crystalline form. They are commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The particle may be a pigment or nanoparticle.

By “pigment” it is meant that the titanium dioxide particles have an average size of less than 1 micron. Typically, the particles have an average size of from about 0.020 to about 0.95 microns, more typically, about 0.050 to about 0.75 microns and most typically about 0.075 to about 0.50 microns. By “nanoparticle” it is meant that the primary titanium dioxide particles typically have an average particle size diameter of less than about 100 nanometers (nm) as determined by dynamic light scattering that measures the particle size distribution of particles in liquid suspension. The particles are typically agglomerates that may range from about 3 nm to about 6000 nm.

The titanium dioxide particle can be substantially pure titanium dioxide or can contain other metal oxides, such as alumina. Other metal oxides may become incorporated into the particles, for example, by co-oxidizing, post-oxidizing, co-precipitating titanium compounds with other metal compounds, or precipitating other metal compounds on to the surface of the titanium dioxide particles. These are typically hydrous metal oxides. If co-oxidized, post-oxidized, or precipitated, or co-precipitated the amount of the metal oxide is about 0.06 to about 5%, more typically about 0.2% to about 4%, still more typically about 0.5% to about 3%, and most typically about 0.8% to about 2%, based on the total weight of the titanium dioxide particles. Tungsten may also be introduced into the particle using co-oxidizing, or post-oxidizing. If co-oxidized or post-oxidized at least about 0.002 wt. % of the tungsten, more typically, at least about 0.004 wt. %, still more typically at least about 0.01 wt. % tungsten, and most typically at least about 0.05 wt. % may be present, based on the total particle weight.

### Process for Preparing Treated Titanium Dioxide Particles

The process for producing titanium dioxide particle comprises:

a) mixing of chlorides of, titanium, tungsten or mixtures thereof; wherein at least one of the chlorides is in the vapor phase;

(b) oxidizing the chlorides of, titanium, tungsten or mixtures thereof; and

(c) forming titanium dioxide (Ti0₂) particles comprising at least about 0.002% of tungsten, more typically at least about 0.004% of tungsten and still more typically at least about 0.01% of tungsten, and most typically at least about 0.05% of tungsten, based on the total weight of the titanium dioxide particles. These titanium dioxide particles have a photostability ratio (PSR) of at least 2, more typically at least 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the titanium dioxide particles comprising tungsten further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the titanium dioxide particles.

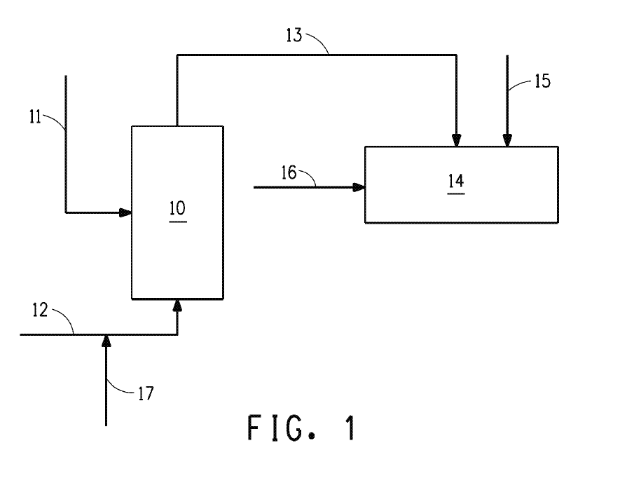

Methods known to one skilled in the art may be used to add tungsten to the titanium dioxide particles. In one specific embodiment, tungsten may be added to the titanium dioxide particle from an alloy comprising tungsten. As shown in FIG. 1, the alloy 11 and chlorine 12 are added to the generator 10. This reaction can occur in fluidized beds, spouting beds, packed beds, or plug flow reactors. The inert generator bed may comprise materials such as silica sand, glass beads, ceramic beads, TiO₂ particles, or other inert mineral sands. The alloy comprising aluminum, titanium or mixtures thereof and tungsten, 11, reacts in the generator 10 according to the following equations:

2Al+3Cl₂→2AlCl₃+heat

Ti+2Cl₂→TiCl₄+heat

W+3Cl₂→WCl₆+heat

Al₁₂W+21Cl₂→12AlCl₃+WCl₆+heat

The heat of reaction from the chlorination of the aluminum or titanium metal helps provide sufficient heat to drive the kinetics of the reaction between chlorine and one or more of the other elements.

Titanium tetrachloride 17 may be present during this reaction to absorb the heat of reaction. The chlorides formed in-situ comprise chlorides of the tungsten and chlorides of aluminum such as aluminum trichloride, chlorides of titanium such as titanium tetrachloride or mixtures thereof. The temperature of the reaction of chlorine with the alloy should be below the melting point of the alloy but sufficiently high enough for the rate of reaction with chlorine to provide the required amount of chlorides to be mixed with the TiCl₄.

Typical amounts of chlorine used in step (a) are about 0.4% to about 20%, more typically about 2% to about 5%, by weight, based on the total amount of all reactants. Typical amounts of titanium tetrachloride are about 75% to about 99.5% added in step (a) and (b), and more typically about 93% to about 98%, by weight, based on the total amount of all reactants.

The reaction of chlorine with the alloy occurs at temperature of above 190° C., more typically at temperature of about 250° C. to about 650° C., and most typically at temperatures of about 300° C. to about 500° C. In one specific embodiment where the metal is Ti the reaction occurs at temperature of above 50° C. (bp of TiCl₄=136° C.), more typically at temperature of about 200° C. to about 1000° C. , and most typically at temperatures of about 300° C. to about 500° C.

The chlorides formed in the in-situ step 13 flows into an oxidation reactor 14 and titanium tetrachloride 15 is then added to the chlorides, such that titanium tetrachloride is present in a major amount. Vapor phase oxidation of the chlorides from step (a) and titanium tetrachloride is by a process similar to that disclosed, for example, in U.S. Pat. Nos. 2,488,439, 2,488,440, 2,559,638, 2,833,627, 3,208,866, 3,505,091, and 7,476,378. The reaction may occur in the presence of neucleating salts such as potassium chloride, rubidium chloride, or cesium chloride.

Such reaction usually takes place in a pipe or conduit, wherein oxygen 16, titanium tetrachloride 15 and the in-situ formed chlorides comprising chlorides of tungsten and chlorides of aluminum such as aluminum trichloride, chlorides of titanium such as titanium tetrachloride or mixtures thereof 13 are introduced at a suitable temperature and pressure for production of the treated titanium dioxide. In such a reaction, a flame is generally produced.

Downstream from the flame, the treated titanium dioxide produced is fed through an additional length of conduit wherein cooling takes place. For the purposes herein, such conduit will be referred to as the flue. The flue should be as long as necessary to accomplish the desired cooling. Typically, the flue is water cooled and can be about 50 feet (15.24 m) to about 3000 feet (914.4 m), typically about 100 feet (30.48 m) to about 1500 feet (457.2 m), and most typically about 200 feet (60.96 m) to 1200 feet (365.76 m) long.

The following Examples illustrate the present disclosure. All parts, percentages and proportions are by weight unless otherwise indicated.

### EXAMPLES

Photostability ratio (PSR) is the rate of photoreduction of Ag+ by TiO₂ particles without tungsten (control samples) divided by the rate of photoreduction of Ag+ by the otherwise same TiO₂ particles comprising tungsten. The rate of photoreduction of Ag+ can be determined by various methods. A convenient method was to suspend the TiO₂ particles in 0.1 M AgNO₃ aqueous solution at a fixed ratio of TiO₂ to solution, typically 1:1 by weight. The suspended particles were exposed to UV light at about 0.2 mW./cm² intensity. The reflectance of visible light by the suspension of TiO₂ particles was monitored versus time. The reflectance decreased from the initial value to smaller values as silver metal was formed by the photoreduction reaction, Ag⁺->Ag^{O}. The rate of reflectance decrease versus time was measured from the initial reflectance (100% visible reflectance with no UV light exposure) to a reflectance of 90% after UV exposure; that rate was defined as the rate of Ag⁺ photoreduction.

Color as measured on the CIE 1976 color scale , L*, a*, and b*, was measured on pressed pellets of dry TiO₂ powder.

### Comparative Example 1

Titanium dioxide made by the chloride process comprising 1.23% alumina by weight and having an L*a*b* color index of (99.98, 0.60, 2.13) and a rate of Ag⁺ photoreduction of 0.0528 sec⁻¹ was fired under flowing oxygen at 4° C./min to 1000° C. and held at temperature for 3 hours; furnace cooled to 750° C. and held at temperature for 1 hour; furnace cooled to 500° C. and held at temperature for 3 hours; furnace cooled to 250° C. and held at temperature for 3 hours; and finally furnace cooled to room temperature. After firing the sample had an L*a*b* color index of (99.15, −0.45, 2.17) and a rate of Ag⁺photoreduction of 0.1993 sec⁻¹.

### Comparative Example 2

Titanium dioxide made by the chloride process comprising 0.06% alumina by weight and having an L*a*b* color index of (99.43, −0.58, 1.36) and a photoactivity rate of 0.3322 was fired under flowing oxygen at 4° C./min to 1000° C. and held at temperature for 3 hours; furnace cooled to 750° C. and held at temperature for 1 hour; furnace cooled to 500° C. and held at temperature for 3 hours; furnace cooled to 250° C. and held at temperature for 3 hours; and finally furnace cooled to room temperature. After firing the sample had an L*a*b* color index of (97.71, −0.03, 1.89) and a photoactivity rate of 0.2229 sec⁻¹.

### Example 3

Titanium dioxide similar to that described in Comparative Example 1 was well mixed with various amounts of ammonium tungstate, (NH₄)₁₀W₁₂O₄₁.5H₂O, to give samples having the W contents listed below. These samples were fired as described in Comparative Example 1. After firing the samples had L*a*b* color and photostability ratios (PSR) as given in the following table:

| W (wt. %) | L* | a* | b* | PSR |
|---|---|---|---|---|
| 0.0 | 99.15 | −0.45 | 2.17 | 1.0 |
| 0.34 | 99.00 | −0.71 | 2.72 | 3.0 |
| 1.72 | 98.56 | −0.82 | 3.17 | 10.4 |
| 3.44 | 98.41 | −0.90 | 3.11 | 211.4 |

The increased incorporation of W clearly enhanced photostability up to roughly a factor of 200 while the color was only minimally affected.

### Example 4

Titanium dioxide similar to that described in Comparative Example 1 was impregnated via incipient wetness with various amounts of ammonium tungstate, (NH₄)₁₀W₁₂O₄₁.5H₂O, to give samples having the W contents listed below. These samples were fired as described in Comparative Example 1. After firing the samples had L*a*b* color and photostability ratios as given in the following table:

| W (wt. %) | L* | a* | b* | PSR |
|---|---|---|---|---|
| 0.0 | 98.16 | 0.02 | 2.09 | 1.0 |
| 0.34 | 97.97 | −0.02 | 2.53 | 2.2 |
| 1.72 | 97.52 | −0.15 | 2.79 | 10.0 |
| 3.44 | 97.41 | −0.53 | 3.34 | 67.4 |

The increased incorporation of W clearly enhanced photostability up to roughly a factor of 67 while the color index was only minimally affected.

### Example 5

Titanium dioxide similar to that described in Comparative Example 2 was well mixed with amounts of ammonium tungstate, (NH₄)₁₀W₁₂O₄₁.5H₂O, to give samples having the W contents listed below. These samples were fired as described in Comparative Example 1. After firing the samples had L*a*b* color and photostability ratios as given in the following table:

| W (wt. %) | W | L* | a* | b* | PSR |
|---|---|---|---|---|---|
| 0.0 | 0.0 | 97.71 | −0.03 | 1.89 | 1.0 |
| 0.34 | 1x | 97.73 | −0.21 | 2.19 | 4.3 |
| 1.72 | 5x | 97.18 | −0.56 | 1.94 | 139.0 |
| 3.44 | 10x | 97.03 | −0.83 | 2.45 | 113.8 |

The increased incorporation of W clearly enhanced photostability up to roughly a factor of 140 while the color index was only minimally affected.

### Comparative Example 6

Titanium dioxide similar to that described in Comparative Example 1 was well mixed with various amounts of ammonium molybdate, (NH₄)₆Mo₇O₂₄.4H₂O, to give samples having the Mo contents listed below. These samples were fired as described in Comparative Example 1. After firing the samples had L*a*b* color and photostability ratios as given in the following table:

| Mo (wt. %) | L* | a* | b* | PSR |
|---|---|---|---|---|
| 0.0 | 98.76 | −0.37 | 2.48 | 1 |
| 0.18 | 94.08 | −3.45 | 17.96 | 314.8 |
| 0.91 | 93.77 | −4.47 | 30.45 | no rate |
| 1.83 | 91.89 | −5.27 | 35.82 | no rate |

The increased incorporation of Mo clearly enhanced photostability to the point where, at the higher Mo concentrations, the photostability ratio could not be determined. However, the material took on a decidedly yellow coloration clearly compromising its use as a white pigment.

### Comparative Example 7

Titanium dioxide similar to that described in Comparative Example 1 was impregnated via incipient wetness with various amounts of ammonium molybdate, (NH₄)₆Mo₇O₂₄.4H₂O, to give samples having Mo to Al atomic ratios of 0.1, 0.5, and 1.0 versus 0.0 for the undoped control. These samples were fired as described in Comparative Example 1. After firing the samples had L*a*b* color and photostability ratios as given in the following table:

| Mo (wt. %) | L* | a* | b* | PSR |
|---|---|---|---|---|
| 0.0 | 97.79 | −0.19 | 2.57 | 1.0 |
| 0.18 | 92.62 | −3.61 | 24.15 | 862.3 |
| 0.91 | 92.66 | −4.21 | 31.63 | 1188.0 |
| 1.83 | 90.74 | −4.92 | 37.94 | no rate |

The incorporation of Mo clearly enhanced photostability to the point where, at the highest Mo concentration, the photostability ratio could not be determined. However, the material took on a decidedly yellow coloration clearly compromising its use as a white pigment.

### Example 8

Titanium dioxide samples having the W contents as listed in Example 3 are compounded into polyethylene (NA206. Equistar) at a 50 wt. % product loading using a 30 mm co-rotating twin screw extruder (Werner and Pfleiderer) set up to extrude masterbatch at 50, 60 and 70 pounds/hour (22.7, 27.2 and 31.8 kgs./hour) rates (300 rpm screw speed, with all barrel temperature controllers set to 150° C.). A general purpose screw design is used as can standard post-compounding equipment consisting of a strand die, a cooling water trough and an air knife to produce pellets.

### Example 9

Titanium dioxide samples having the W contents as listed in Example 3 are compounded into polyethylene (NA206, Equistar) using a batch internal mixer (Farrel Banbury® BR1600) at a 50 wt. % pigment loading (76 vol. % fill factor). The resulting masterbatches are ground into small pieces and then individually let down at 420° F. (215.6° C.) to 10 wt. % TiO₂ with injection molding grade polypropylene (Montell PH-920S) using a Cincinnati-Milacron (Vista VT85-7) injection molder. The molder can produce 1¾ inches×3 inches×⅛ inch (4.45 cm×7.62 cm×0.318 cm) chips.

### Example 10

Polyethylene masterbatch containing 50 wt. % TiO₂ as produced in Example 8 is let down to 5 wt. % TiO₂ with additional polyethylene. This composition is degassed while still hot and is formed into a film by running it through a two-roll mill repeatedly [5 times, 35 mil roller gap, 220° F. (104.4° C.) and 240° F. (115.6° C.) roller temperatures] to produce a ˜35 mil thick film.

What is claimed is:

1. A polymer composition comprising an inorganic particle, wherein the inorganic particle comprises at least about 0.002% of tungsten, based on the total weight of the inorganic particle, and has a photostability ratio (PSR) of at least about 2, as measured by the Ag⁺ photoreduction rate, and color as depicted by an L* of at least about 97.0, and b* of less than about 4.

2. The polymer composition of claim 1 wherein the inorganic particle is an inorganic metal oxide or mixed metal oxide particle.

3. The polymer composition of claim 2 wherein the inorganic metal oxide particle is titanium dioxide.

4. The polymer composition of claim 3 further comprising a polymer, wherein the polymer is a high molecular weight melt processable polymer.

5. The polymer composition of claim 4 wherein the high molecular weight melt processable polymer is in the form of a particle, granule, pellet or cube.

6. The polymer composition of claim 3 wherein the amount of the titanium dioxide in the polymer composition ranges from about 30 to about 90 wt. %, based on the total weight of the polymer composition.

7. The polymer composition of claim 6 wherein the amount of the titanium dioxide in the polymer composition ranges from about 50 to about 80 wt. %, based on the total weight of the polymer composition.

8. The polymer composition of claim 3 wherein tungsten is present in the amount of at least about 0.004%, based on the total weight of the inorganic particle.

9. The polymer composition of claim 3 wherein the photostability ratio (PSR) is at least about 4.

10. The polymer composition of claim 3 wherein L* is at least about 98.

11. The polymer composition of claim 3 wherein B* is less than about 3.

12. The polymer composition of claim 3 wherein the titanium dioxide particle further comprises alumina in the amount of about 0.06 to about 5% based on the total weight of the titanium dioxide particle.

13. The polymer composition of claim 3 wherein the polymer composition is a masterbatch.

14. A plastic part prepared from a polymer composition, wherein the polymer composition comprises an inorganic particle, wherein the inorganic particle comprises at least about 0.002% of tungsten, based on the total weight of the inorganic particle, and has a photostability ratio (PSR) of at least about 2, as measured by the Ag⁺ photoreduction rate, and color as depicted by an L* of at least about 97.0, and b* of less than about 4.

15. The plastic part of claim 14 comprising a shaped article.

16. The plastic part of claim 15 wherein the shaped article comprises tubing, pipe, wire coating, or film.

17. The plastic part of claim 16 wherein the film is a blown film.

18. The plastic part of claim 14 wherein the inorganic particle is an inorganic metal oxide or mixed metal oxide particle.

19. The plastic part of claim 18 wherein the wherein the inorganic metal oxide particle is titanium dioxide.

20. The plastic part of claim 14 wherein the inorganic particle is present in the amount of about 0.01 to about 20 wt. %, based on the weight of the plastic part.
